(19) United States
(12) Patent Application Publication
(10) Pub. No.: US 2015/0060361 A1
(43) Pub. Date: Mar. 5, 2015

(54) DRAW SOLUTES INCLUDING AMINO ACID IONIC OLIGOMERS

(71) Applicant: Samsung Electronics Co., Ltd., Suwon-Si (KR)

(72) Inventors: Bo Kyung JUNG, Yongin-si (KR); Won Cheol JUNG, Seoul (KR); Seung Rim YANG, Seongnam-si (KR); Sung Soo HAN, Hwaseong-si (KR)

(21) Appl. No.: 14/467,346

(22) Filed: Aug. 25, 2014

(30) Foreign Application Priority Data
Sep. 5, 2013 (KR) 10-2013-0106804

(51) Int. Cl. B01D 61/00; C02F 1/38; C08G 69/10; C02F 1/44

(52) U.S. Cl. CPC B01D 61/005; C02F 1/445; C02F 1/444; C02F 1/442; C02F 1/38; C08G 69/10; B01D 2311/2649; C02F 2103/08
USPC 210/648; 210/195.2; 564/153

(57) ABSTRACT

A draw solute including an oligomer having an amino acid repeating unit with an ionic moiety and a counter ion thereof, and a forward osmosis water treatment device and method using the same are provided.

### CROSS-REFERENCE TO RELATED APPLICATIONS

This application claims priority under 35 U.S.C. §119 from Korean Patent Application No. 10-2013-0106804, filed in the Korean Intellectual Property Office on Sep. 5, 2013, the entire contents of which are incorporated herein by reference.

### BACKGROUND

1. Field

Example embodiments relate to draw solutes including amino acid ionic oligomers, and/or forward osmosis water treatment devices and methods using the same.

2. Description of the Related Art

Osmosis (or forward osmosis) refers to a phenomenon wherein water moves from a lower solute concentration solution to a solution of a higher solute concentration by osmotic pressure. Reverse osmosis is a method of artificially applying pressure to move water in the opposite direction.

Desalination through reverse osmosis is a known technique in the field of water treatment. Reverse osmosis desalination involves artificially applying a relatively high pressure, and thus requires relatively high energy consumption. To increase energy efficiency, a forward osmosis process using the principle of osmotic pressure has been suggested, and as a solute for the osmosis draw solution, ammonium bicarbonate, sulfur dioxide, aliphatic alcohols, aluminum sulfate, glucose, fructose, potassium nitrate, and the like have been used. Among them, an ammonium bicarbonate draw solution is most commonly used, and after the forward osmosis process, the draw solute (i.e., ammonium bicarbonate) may undergo decomposition into ammonia and carbon dioxide at a temperature of about 60° C. and be removed. Further, newly suggested draw solutes include magnetic nanoparticles having hydrophilic polymers such as peptides and low molecular weight materials attached thereto (that can be separated by a magnetic field), a polymer electrolyte such as a dendrimer (that can be separated by a ultrafiltration (UF) or nanofiltration (NF) membrane), and the like.

Because decomposition of ammonium bicarbonate requires heating at about 60° C. or higher, removal of the draw solute including the above compound requires a relatively high level of energy consumption. In addition, because a complete elimination of ammonia is difficult (if not impossible), water produced by forward osmosis using ammonium bicarbonate as the draw solute is typically not suitable for drinking water due to the odor of ammonia. Meanwhile, magnetic nanoparticles present difficulties in terms of redispersing the agglomerated particles being separated from the draw solution by using a magnetic field. It is also difficult (if not impossible) to completely remove the nanoparticles. Thus, the toxicity of the nanoparticles may be an additional disadvantage. Polyionic draw solutes may generate a high level of osmotic pressure, but they tend to diffuse into a feed solution, which leads to severe loss of the draw solute. In addition, the recovery of the draw solutes requires a tight nano-filtration membrane and thus requires a high energy process. Moreover, such draw solutes generally exhibit a high level of toxicity, and therefore are typically difficult to use in a forward osmosis process for producing drinking water.

### SUMMARY

Some example embodiments relate to amino acid draw solutes that may realize high water flux and low reverse salt flux, and may exhibit a relatively low level of toxicity.

Some example embodiments relate to forward osmosis water treatment devices and methods using a draw solution including such draw solutes.

According to at least one example embodiment, a draw solute may include an oligomer including an amino acid repeating unit having an ionic moiety and a counter ion thereof, the oligomer including a repeating unit represented by Chemical Formula 1-1, a repeating unit represented by Chemical Formula 1-2, or a combination thereof:

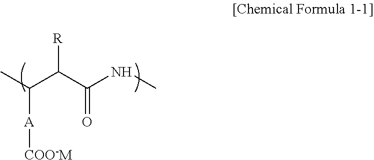

wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and

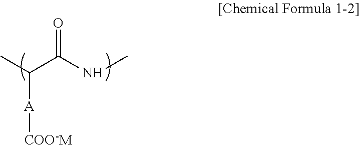

wherein A is a direct bond or a substituted or unsubstituted C1 to C10 alkylene group and M is a cation of an alkali metal or a cation of an alkaline earth metal.

The oligomer may have a number-average molecular weight of about 500 g/mol to about 10,000 g/mol as measured with gel permeation chromatography.

The oligomer may have a number-average molecular weight of about 1,000 g/mol to about 8,000 g/mol as measured with a gel permeation chromatography.

The oligomer may have a number-average molecular weight of about 1000 g/mol to about 7000 g/mol as measured with gel permeation chromatography.

The oligomer may have a main chain of polyaspartic acid, a main chain of polyglutamic acid, or a combination thereof.

The counter ion may be Na⁺, Li⁺, K⁺, Rb+, Ca²⁺, Mg²⁺, or Ba²⁺.

The draw solute may generate an osmotic pressure of greater than or equal to about 10 atm when the osmotic pressure is measured for a solution including the oligomer at a concentration of about 0.2 g/ml via a freezing point depression method.

The draw solute may show a reverse salt flux of less than or equal to about 1 GMH when it is measured for a solution including the oligomer at a concentration of less than or equal to about 0.5 g/ml.

The draw solute may have a water flux of greater than or equal to about 4 LMH at an osmotic pressure of about 20 atm.

According to at least one example embodiment, a forward osmosis water treatment device may include a feed solution including water and materials to be separated being dissolved in water; an osmosis draw solution including a draw solute including an oligomer having an amino acid repeating unit with an ionic moiety and a counter ion, the oligomer including a repeating unit represented by Chemical Formula 1-1, a repeating unit represented by Chemical Formula 1-2, or a combination thereof:

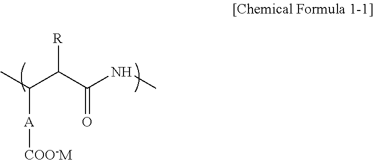

wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and

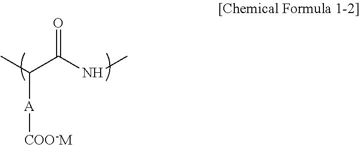

wherein A is a direct bond or a substituted or unsubstituted C1 to C10 alkylene group and M is a cation of an alkali metal or a cation of an alkaline earth metal; a semi-permeable membrane contacting the feed solution on one side and the osmosis draw solution on the other side; a recovery system for removing the oligomer from a treated solution including water that moves from the feed solution to the osmosis draw solution through the semipermeable membrane by osmotic pressure; and a connector for reintroducing the oligomer removed from the recovery system to the osmosis draw solution.

The forward osmosis water treatment device may further include an outlet for discharging treated water produced by removing the oligomer from the treated solution in the recovery system.

The recovery system may include a microfiltration (MF) membrane, an ultrafiltration (UF) membrane, a loose nanofiltration (NF) membrane, or a centrifugal separator.

According to at least one example embodiment, a forward osmosis method for water treatment may include contacting a feed solution including water and materials to be separated being dissolved in water and an osmosis draw solution with a semi-permeable membrane positioned therebetween to obtain a treated solution including the water that moves from the feed solution to the draw solution through the semi-permeable membrane by osmotic pressure, the osmosis draw solution including a draw solute including a oligomer having an amino acid repeating unit with an ionic moiety and a counter ion, the oligomer including a repeating unit represented by Chemical Formula 1-1, a repeating unit represented by Chemical Formula 1-2, or a combination thereof:

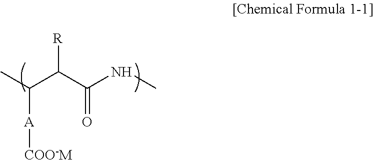

wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and

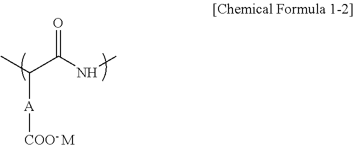

wherein A is a direct bond or a substituted or unsubstituted C1 to C10 alkylene group and M is a cation of an alkali metal or a cation of an alkaline earth metal; removing the oligomer from the treated solution to obtain treated water; and discharging the treated water.

The aforementioned example ionic oligomer may provide a draw solution that may generate high osmotic pressure and exhibit enhanced forward osmosis performance such as, for example, increased water flux and decreased reverse salt flux. Therefore, the forward osmosis water treatment devices and methods using the same may be operated at higher efficiency of water treatment.

### BRIEF DESCRIPTION OF THE DRAWINGS

FIG. 1 is a schematic view of a forward osmosis water treatment device according to at least one example embodiment.

FIG. 2 is a ¹H-NMR analysis spectrum of the ionic oligomer (OAspNa), according to at least one example embodiment.

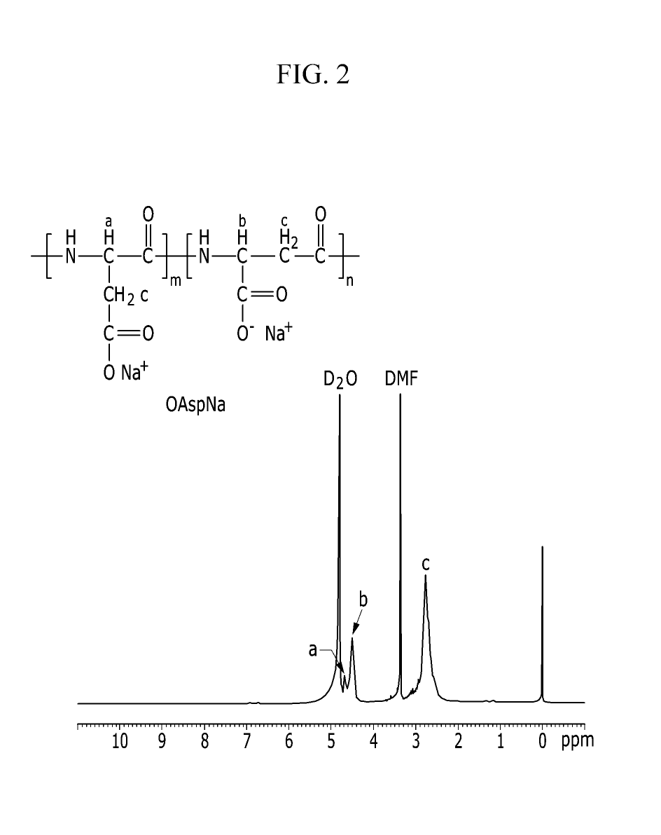

FIG. 3 is a graph plotting the changes in the osmotic pressure depending on the concentration, according to at least one example embodiment.

FIG. 4 is a graph plotting the changes in the osmotic pressure depending on the concentration, according to at least one example embodiment.

FIG. 5 is a graph plotting the changes in the osmotic pressure depending on the concentration, according to at least one example embodiment.

FIG. 6 is a graph showing the results of water flux, according to at least one example embodiment.

FIG. 7 is a graph showing the results of reverse salt flux, according to at least one example embodiment.

### DETAILED DESCRIPTION

It will be understood that when an element or layer is referred to as being “on,” “connected to,” “coupled to,” or “covering” another element or layer, it may be directly on, connected to, coupled to, or covering the other element or layer, or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of the example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of the example embodiments. As such, variations from the shapes of the illustrations as a result, for example, of manufacturing techniques and/or tolerances, are to be expected. Thus, the example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, the term “substitute” refers to replacing one or more of hydrogen in a corresponding group with a hydroxyl group, a nitro group, a cyano group, an amino group, a carboxyl group, a linear or branched C1 to C30 alkyl group, a C1 to C10 alkyl silyl group, a C3 to C30 cycloalkyl group, a C6 to C30 aryl group, a C2 to C30 heteroaryl group, a C1 to C10 alkoxy group, a halogen, or a C1 to C10 fluoro alkyl group.

An example embodiment provides a draw solute including an oligomer having an amino acid repeating unit with an ionic moiety and a counter ion thereof. The oligomer may include a repeating unit represented by Chemical Formula 1-1, a repeating unit represented by Chemical Formula 1-2, or a combination thereof:

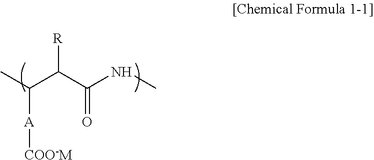

wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and

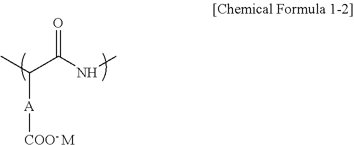

wherein A is a direct bond or a substituted or unsubstituted C1 to C10 alkylene group and M is a cation of an alkali metal or a cation of an alkaline earth metal. The counter ion may be Na⁺, Li⁺, K⁺, Rb+, Ca²⁺, Mg²⁺, or Ba²⁺.

The oligomer may have a polyaspartic acid main chain represented by Chemical Formula 2 and a monovalent cation of an alkali metal such as Na⁺, or may have a polyglutamic acid main chain represented by Chemical Formula 3 and a monovalent cation of an alkali metal such as Na⁺:

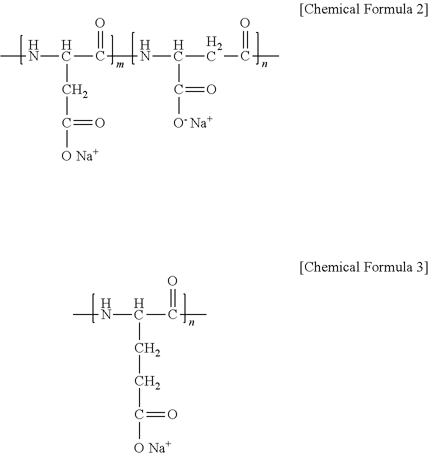

According to at least one example embodiment, the aforementioned amino acid ionic oligomer includes the counter ion, and has an appropriate molecular weight so that the amino acid ionic oligomer may generate high osmotic pressure and exhibit a low level of reverse salt flux as well. In addition, the amino acid ionic oligomer may have a relatively short chain length so that its diffusion ability is high.

The oligomer may have a number-average molecular weight of about 500 g/mol to about 10,000 g/mol, for example, about 1000 g/mol to about 8000 g/mol, or about 1000 g/mol to about 7000 g/mol when measured with gel permeation chromatography (GPC). In an embodiment, an aspartic acid based ionic oligomer may have a number-average molecular weight of 1,300 g/mol to 6,800 g/mol, and a glutamic acid based ionic oligomer may have a number average molecular weight of 750 g/mol to 5,500 g/mol. Such range of the molecular weight may be translated to a polymerization degree of about 4 to about 70, and thus the main chain may have an appropriate length. In addition, the counter ion located at the end of the carboxylic acid enables the polymer chain to have a stretched conformation, which makes it possible to keep the reverse salt flux at a low level.

When the draw solute is prepared as a draw solution including the oligomer at a concentration of about 0.2 g/ml, the draw solution may generate an osmotic pressure of greater than or equal to about 10 atm when being measured in accordance with a freezing point depression method. In addition, the draw solute may exhibit a reverse salt flux of less than or equal to about 1 GMH when measured for a solution including the oligomer at a concentration of less than or equal to about 0.5 g/ml. Moreover, the draw solute may exhibit a water flux of greater than or equal to about 4 LMH at an osmotic pressure of about 20 atm. In other words, the draw solute may provide an appropriate level of osmotic pressure while exhibiting a high level of the water flux and a low level of the reverse salt flux. Furthermore, the oligomer has a polyamino acid main chain and includes ionic moieties and counter ions and thus has biodegradability and biocompatibility (e.g., a low level of toxicity), and therefore the oligomer may find applications in water treatment for providing usable or drinking water.

The oligomer may be a homopolymer. The oligomer may be a copolymer such as a random copolymer, a block copolymer, or a graft copolymer.

The amino acid ionic oligomer may be prepared in accordance with any known methods. In non-limiting examples, the ionic oligomer may be provided by reacting aspartic acid in the presence of an acid catalyst (e.g., a phosphoric acid) to obtain a poly(succinimide) (PSI) polymer having a predetermined molecular weight, and treating the same with an inorganic base such as sodium hydroxide or potassium hydroxide (see Reaction Scheme 1).

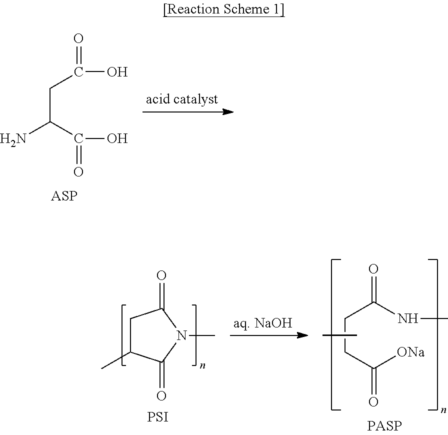

In other non-limiting examples, the ionic oligomer may be prepared by treating a polyglutamic acid polymer having a predetermined molecular weight with an inorganic base. The polyglutamic acid polymer having a predetermined molecular weight may be prepared in any known methods. For example, the polyglutamic acid polymer may be prepared in accordance with Reaction Scheme 2.

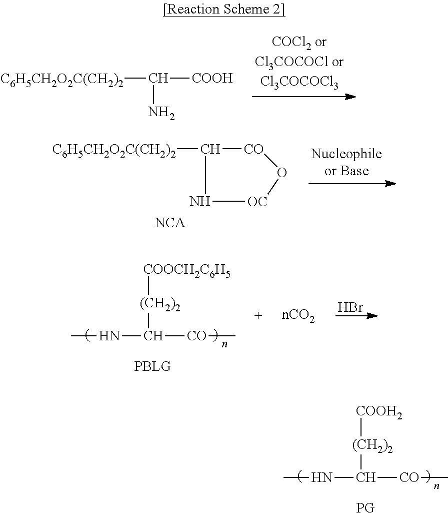

The nucleophile may be a primary amine or an alkoxide anion. The base may be an aliphatic primary or tertiary amine

Examples of the inorganic base may include, but are not limited to, an alkali metal hydroxide such as NaOH, KOH, LiOH, or RbOH, and an alkaline earth metal hydroxide such as Ca(OH)₂, Mg(OH)₂, or Ba(OH)₂.

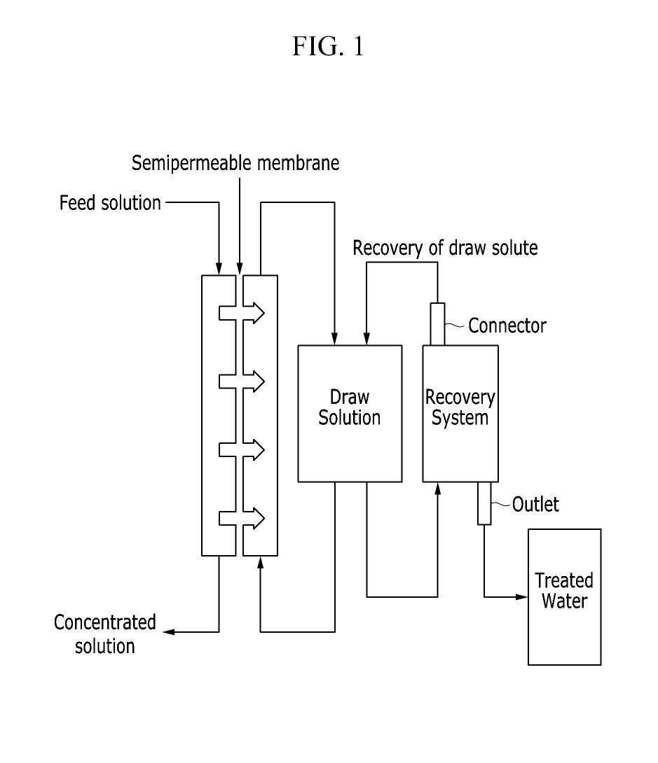

According to another example embodiment, a forward osmosis water treatment device may include a draw solution containing the aforementioned amino acid ionic oligomer. The forward osmosis water treatment device may include a feed solution including water and materials to be separated being dissolved in the water; an osmosis draw solution including the aforementioned amino acid ionic oligomer and water, a semi-permeable membrane contacting the feed solution on one side and the osmosis draw solution on the other side, a recovery system for removing the amino acid ionic oligomer from a treated solution including water that moves from the feed solution to the osmosis draw solution through the semipermeable membrane by osmotic pressure, and a connector for reintroducing the amino acid ionic oligomer removed from the recovery system to the osmosis draw solution. FIG. 1 shows a schematic view of a forward osmosis water treatment device according to at least one example embodiment that may be operated by the forward osmosis water treatment method that will be explained hereinafter.

According to at least one example embodiment, the semi-permeable membrane is permeable to water and impermeable to the materials to be separated. The types of feed solution are not particularly limited as long as they may be treated in the forward osmosis manner. The materials to be separated may be impurities. Specific examples of feed solution may include, but are not limited to, sea water, brackish water, ground water, waste water, and the like. By way of a non-limiting example, the forward osmosis water treatment device may treat sea water to produce drinking water.

Details for the amino acid ionic oligomer may be the same as those set forth above. The concentration of the osmosis draw solution may be controlled to generate higher osmotic pressure than that of the feed solution.

According to at least one example embodiment, the recovery system may include a microfiltration (MF) membrane, an ultrafiltration (UF) membrane, a nanofiltration (NF) membrane, or a centrifuge for filtration or separation of the ionic oligomer. The oligomer as removed may be introduced into the draw solution again via a connector.

The forward osmosis water treatment device may further include an outlet for discharging treated water produced by removing the amino acid ionic oligomer from the treated solution in the recovery system. The types of outlets for discharging treated water are not particularly limited.

In yet another example embodiment, a forward osmosis method for water treatment may include contacting a feed solution including water and materials to be separated being dissolved in water and an osmosis draw solution including the aforementioned ionic oligomer and water with a semi-permeable membrane positioned therebetween to obtain a treated solution including water that moves from the feed solution to the draw solution through the semi-permeable membrane by osmotic pressure, removing the ionic oligomer from the treated solution to obtain treated water, and discharging the treated water.

When the feed solution and the draw solution are brought into contact with the semipermeable membrane disposed therebetween, water is driven to move from the feed solution through the semi-permeable membrane into the osmosis draw solution by osmotic pressure.

Details for the ionic oligomer, the semi-permeable membrane, and the forward osmosis process are the same as set forth above.

The following examples illustrate one or more embodiments in detail. However, they are examples, and this disclosure is not limited thereto.

### EXAMPLE

### Examples 1 to 6 and Comparative Examples 1 to 6

As set forth in the following Table 1, a commercially available aspartic acid oligomer, a commercially available sodium salt of an aspartic acid oligomer, a sodium salt of a glutamic acid oligomer and a sodium salt of polyaspartic acid, are used as a draw solute in Examples 1 to 6 and in Comparative Examples 1 to 4. In Comparative Examples 5 and 6, magnesium chloride and magnesium sulfate are used as a draw solute of a multivalent salt.

TABLE 1

| | | Number of repeating units having |
|---|---|---|
| | | an ionic group |
| | | (number average molecular |
| | Compound name | weight measured by GPC) |
| Example 1 | OAspNa | about 8 (1313 g/mol)^{note 1} |
| Example 2 | OAspNa10 | about 10 (1400 g/mol) |
| Example 3 | OAspNa30 | about 30 (4100 g/mol) |
| Example 4 | OAspNa50 | about 50 (6800 g/mol) |
| Example 5 | OGluNa-1 | about 5~33 (750~5000 g/mol) |
| Example 6 | OGluNa-2 | about 10~37 (1500~5500 |
| | | g/mol) |
| Comparative | PAspNa130 | about 130 (18, 121 g/mol) |
| Example 1 | | |
| Comparative | OAsp10 | about 10 (1150 g/mol) |
| Example 2 | | |
| Comparative | OAsp30 | about 30 (3450 g/mol) |
| Example 3 | | |
| Comparative | OAsp50 | about 50 (5750 g/mol) |
| Example 4 | | |
| Comparative | MgCl₂ | about 3 |
| Example 5 | | |
| Comparative | MgSO₄ | about 2 |
| Example 6 | | |

^{note 1}the molecular weight of the compound of Example 1 is measured using a water soluble gel permeation chromatography (GPC) system (Breeze System, Waters (USA), solvent: 0.02 N NaNO₃, temperature 30° C., a flow rate 0.8 ml/min). Its number-average molecular weight is 1313 g/mol, its weight average molecular weight is 1496 g/mol, and its polydispersity is 1.20.

### Example 1

### OAspNa: a sodium salt of an aspartic acid oligomer (LANXESS, Baypure DS 100)

### Example 2

### OAspNa10: a sodium salt of an aspartic acid oligomer (Alamanda Polymers, PLD10)

### Example 3

### OAspNa30: a sodium salt of an aspartic acid oligomer (Alamanda Polymers, PLD30)

### Example 4

### OAspNa50: a sodium salt of an aspartic acid oligomer (Alamanda Polymers, PLD50)

### Example 5

### OGluNa-1: a sodium salt of a glutamic acid oligomer (Sigma-Aldrich, Poly-L-glutamic acid sodium salt)

### Example 6

### OGluNa-2: a sodium salt of a glutamic acid oligomer (Sigma-Aldrich, Poly-L-glutamic acid sodium salt)

### Comparative Example 1

### PAspNa130: a synthesized aspartic acid polymer note 2

### Comparative Example 2

### OAsp10: an aspartic acid oligomer (Alamanda

### Comparative Example 3

### OAsp30: an aspartic acid oligomer (Alamanda Polymers, PLD(H)30)

### Comparative Example 4

### OAsp50: an aspartic acid oligomer (Alamanda Polymers, PLD(H)50)

The compounds of Comparative Example 2 to Comparative Example 4 are not metal salts.

note 2: the polymer is synthesized in the following manner:

40 g (0.30 mol) of L-aspartic acid and 15 mmol of phosphoric acid are dispersed in 200 ml of sulfolane, and a reaction is carried out under nitrogen purging at a temperature of 170° C. for 10 h. During the reaction, water is removed using a Dean-stark trap, and after the reaction, an excess amount of methanol is added to precipitate the reaction product, which is obtained in the form of a powder. After washing the product with water until the pH of the product is neutral, the resulting product is finally washed with methanol and dried in a vacuum oven at 80° C. to provide polysuccinimide. 1.4 g of NaOH is dissolved in distilled water, and the resulting solution is slowly added to 3 g of the polysuccinimide as synthesized above and a reaction proceeds at a temperature of less than or equal to 10° C. for 1 h. The reaction product is precipitated in 300 mL of methanol to prepare a powdered product, which is then washed two times with methanol and dried in a vacuum oven at a temperature of 40° C. to obtain an aspartic acid polymer.

The molecular weight of the aspartic acid polymer as synthesized is measured using a water soluble GPC system (Breeze System, Waters (USA), solvent: 0.02 N NaNO₃, temperature 30° C., a flow rate of 0.8 ml/min). Its number-average molecular weight is 18,121 g/mol, its weight average molecular weight is 19,333 g/mol, and its polydispersity is 1.06.

### Experimental Example 1

### Evaluation of Osmotic Pressure I

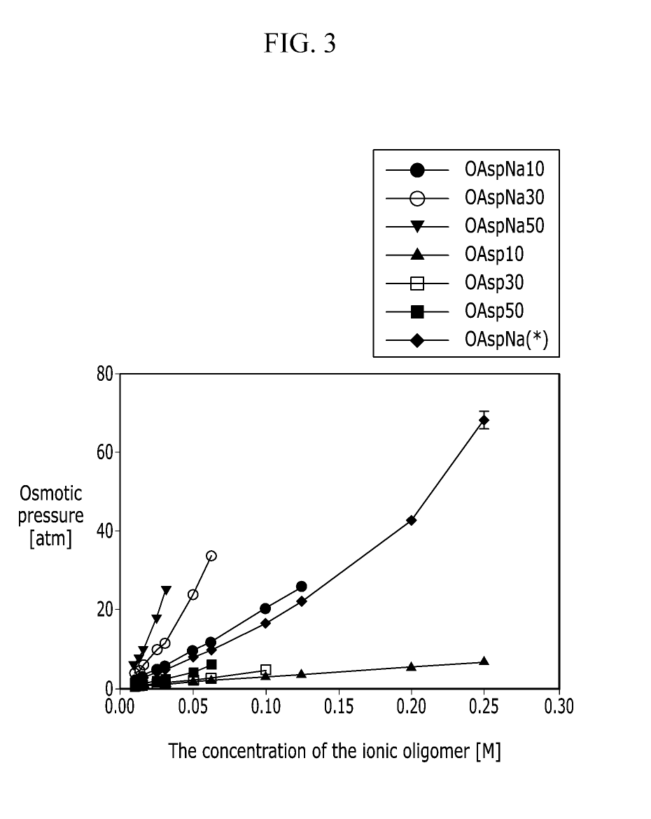

The draw solutions including an oligomer of Examples 1 to 4 and the draw solutions including the oligomer of Comparative Examples 1 to 4 are prepared to have various concentrations. The osmotic pressure of each draw solution is measured by using osmotic pressure measurement equipment (Osmomat 090, Gonotek) in accordance with the membrane measurement method. The results are shown in FIG. 3. The results of FIG. 3 confirm that the draw solute of Examples 1 to 4 may generate a higher level of osmotic pressure in comparison with the draw solute of Comparative Examples 2 to 4.

### Experimental Example 2

### Evaluation of Osmotic Pressure II

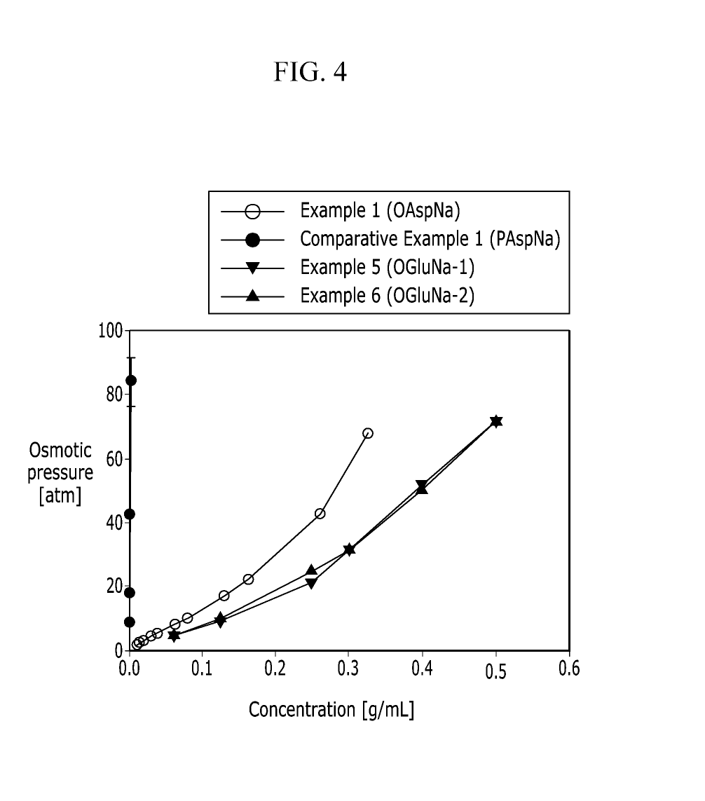

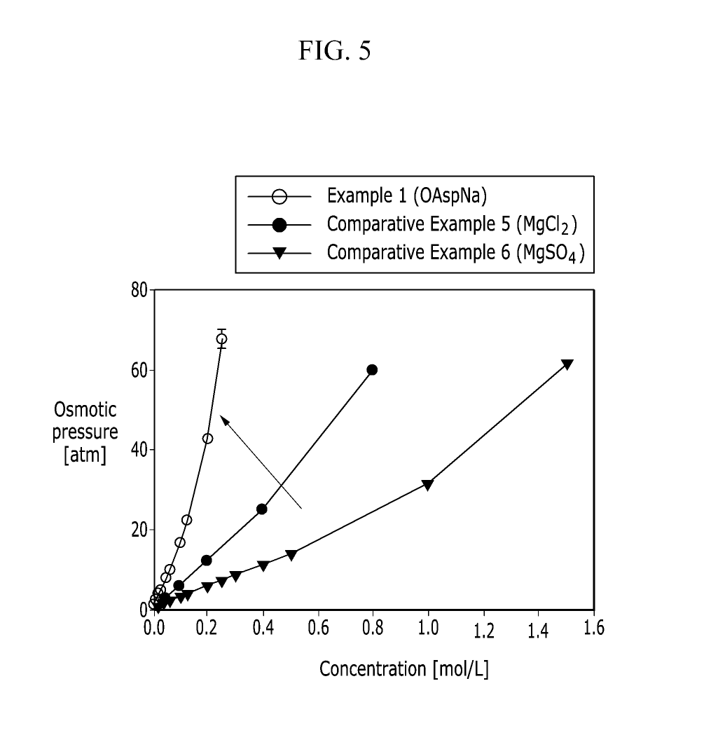

For the draw solutions including the draw solutes of Example 1, Example 5, Example 6, Comparative Example 5, and Comparative Example, respectively, osmotic pressure of each draw solution is measured in the same manner as in Experimental Example 1. The results are shown in FIG. 4 and FIG. 5.

The results of FIG. 4 confirm that the draw solutions including the draw solutes of Example 1, Example 5, and Example 6, respectively, may exhibit an appropriate level of osmotic pressure in a practical or usable range. The results of FIG. 5 confirm that the draw solution including the draw solute of Example 1 may exhibit higher osmotic pressure at a lower concentration than the multivalent salt draw solute of Examples 5 and 6. The sodium salt of the aspartic acid oligomer of Example 1 may have an ionic group and a counter ion thereof per each repeating unit, and thus may have more ionic groups contributing to the osmotic pressure at the same mole number when compared with the multivalent salt, and this may be translated into a higher osmotic pressure.

### Experimental Example 3

### Water Flux and Reverse Salt Flux

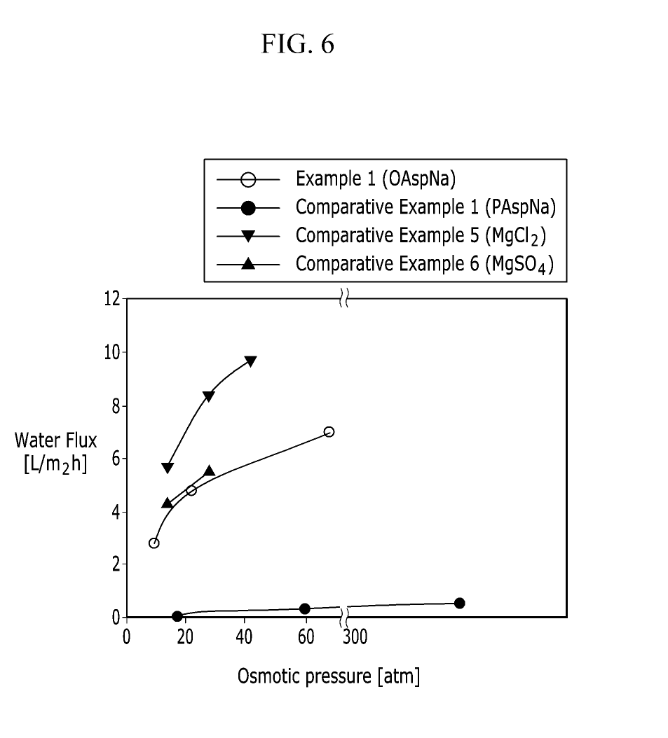

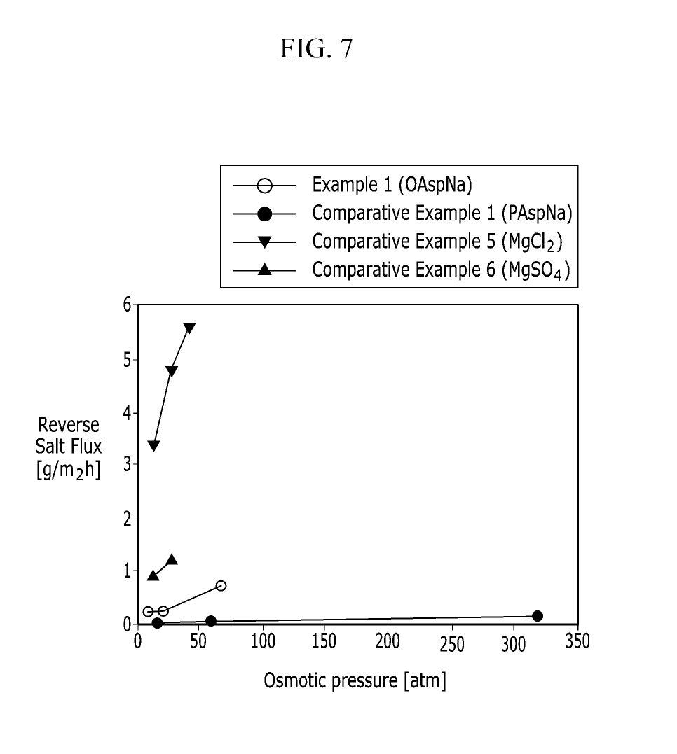

With respect to the draw solutions including, as a draw solute, the oligomer of Example 1, the polymer of Comparative Example 1, and the multivalent salts of Comparative Examples 5 and 6, respectively, an osmotic flow analysis is conducted as follows: the osmotic flow is evaluated with a hand-made, U-shaped semi-dynamic forward osmosis apparatus. To test performance of the draw solute, a semi-permeable commercialized FO membrane (cellulose trifluoroacetate) (Hydration Technology Innovation (HTI), USA) is placed in the middle of the apparatus. Each side is filled with distilled water as a feed solution and a draw solution with predetermined concentrations, respectively. The selective layer is faced toward the feed solutions, and osmotic water flux from feed to draw solutions is calculated from the volumetric change of each solution during 1 h after 30 min. The reversed solute flux from draw to feed solution through the membrane is measured by conductivity, inductively coupled plasma optical emission spectroscopy (ICP-OES), and total organic carbon (TOC). The results are shown in FIG. 6 and FIG. 7.

The results of FIG. 6 confirm that the oligomer of Example 1 may exhibit a much higher level of water flux than the polymer of Comparative Example 1. PASPNa of Comparative Example 1 exhibits a substantially low level of water flux of 0.5 LMH at a concentration corresponding to 320 atm. PASPNa of Comparative Example 1 may generate an increased level of osmotic pressure as it has a larger molecular weight, but has difficulty in diffusing into the membrane. Therefore, PASPNa of Comparative Example 1 fails to enhance the forward osmotic performance. By contrast, the ionic oligomers of Examples 1 to 4 have a suitable molecular weight and distribution thereof for easy diffusion into the membrane, enabling significantly enhanced forward osmotic performance.

The oligomeric salt of Example 1 may have slightly lower water flux than the water flux of MgCl₂, but comparable water flux to MgSO₄.

The results of FIG. 7 confirm that the oligomer of Example 1 may show a significantly reduced level (e.g., decreased by about 74%) of reverse salt flux in comparison with the reverse salt flux of multivalent salts. For draw solutes, having high water flux is important. However, a draw solute having high reverse salt flux may cause a severe loss of the solute, and thus a draw solute having lower reverse salt flux is more suitable to use in a forward osmotic process. Accordingly, the oligomeric sodium salt of Example 1 may exhibit a better performance than the multivalent salt of Comparative Examples 5 and 6.

While example embodiments have been disclosed herein, it should be understood that other variations may be possible. Such variations are not to be regarded as a departure from the spirit and scope of the example embodiments of the present application, and all such modifications as would be obvious to one skilled in the art are intended to be included within the scope of the following claims.

What is claimed is:

1. A draw solute comprising an oligomer including an amino acid repeating unit having an ionic moiety and a counter ion thereof, the oligomer including a repeating unit represented by Chemical Formula 1-1, a repeating unit represented by Chemical Formula 1-2, or a combination thereof: 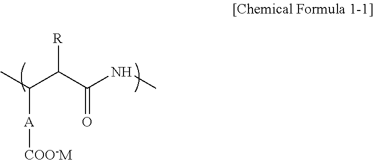
wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and 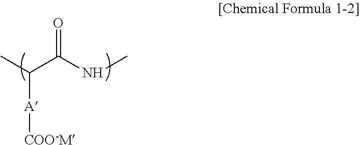
wherein A′ is a direct bond or a substituted or unsubstituted C1 to C10 alkylene group and M′ is a cation of an alkali metal or a cation of an alkaline earth metal.

2. The draw solute of claim 1, wherein the oligomer comprises a main chain of polyaspartic acid, a main chain of polyglutamic acid, or a combination thereof.

3. The draw solute of claim 1, wherein the oligomer has a number-average molecular weight of about 500 g/mol to about 10,000 g/mol.

4. The draw solute of claim 3, wherein the oligomer has a number-average molecular weight of about 1000 g/mol to about 8000 g/mol.

5. The draw solute of claim 1, wherein the counter ion comprises one of Na⁺, Li⁺, K⁺, Rb⁺, Ca²⁺, Mg²⁺, or Ba²⁺.

6. The draw solute of claim 1, wherein an osmotic pressure greater than or equal to about 10 atm is generated by the draw solute for a draw solution including the oligomer at a concentration of about 0.2 g/ml.

7. The draw solute of claim 1, wherein a reverse salt flux of less than or equal to about 1 GMH is exhibited by the draw solute for a draw solution including the oligomer at a concentration of less than or equal to about 0.5 g/ml.

8. The draw solute of claim 1, wherein a water flux of greater than or equal to about 4 LMH at an osmotic pressure of about 20 atm is exhibited by the draw solute.

9. A forward osmosis water treatment device, comprising:
a feed solution including water and materials to be separated, the materials to be separated being dissolved in the water;
an osmosis draw solution including a draw solute including an oligomer having an amino acid repeating unit with an ionic moiety and a counter ion, the oligomer including a repeating unit represented by Chemical Formula 1-1, a repeating unit represented by Chemical Formula 1-2, or a combination thereof; 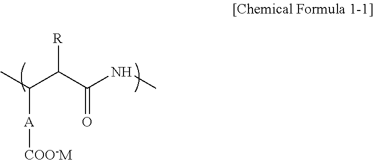
wherein R is hydrogen or a substituted or unsubstituted C1 to C10 alkyl group, A is a direct bond or a substituted or unsubstituted C1 to C10 alkylene group, and M is a cation of an alkali metal or a cation of an alkaline earth metal; and 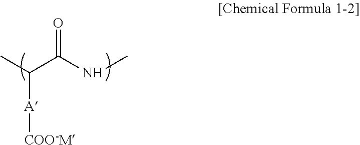
wherein A′ is a direct bond or a substituted or unsubstituted C1 to C10 alkylene group and M′ is a cation of an alkali metal or a cation of an alkaline earth metal;
a semi-permeable membrane having a first side and an opposing second side, the semi-permeable membrane configured such that the feed solution contacts the first side and the osmotic draw solution contacts the second side;
a recovery system configured to remove the oligomer from a treated solution that includes water that has moved from the feed solution to the osmotic draw solution through the semi-permeable membrane by osmotic pressure; and
a connector configured to reintroduce the oligomer that has been removed by the recovery system back into the osmotic draw solution contacting the semi-permeable membrane.

10. The forward osmosis water treatment device of claim 9, wherein the oligomer comprises a main chain of polyaspartic acid, a main chain of polyglutamic acid, or a combination thereof.

11. The forward osmosis water treatment device of claim 9, wherein the oligomer has a number-average molecular weight of about 500 g/mol to about 10,000 g/mol.

12. The forward osmosis water treatment device of claim 11, wherein the oligomer has a number-average molecular weight of about 1000 g/mol to about 8000 g/mol.

13. The forward osmosis water treatment device of claim 9, wherein the counter ion comprises one of Na⁺, Li⁺, K⁺, Rb⁺, Ca²⁺, Mg²⁺, or Ba²⁺.

14. The forward osmosis water treatment device of claim 9, wherein an osmotic pressure greater than or equal to about 10 atm is generated by the draw solute when the osmotic draw solution includes the oligomer at a concentration of about 0.2 g/ml.

15. The forward osmosis water treatment device of claim 9, wherein a reverse salt flux of less than or equal to about 1 GMH is exhibited by the draw solute when the osmotic draw solution includes the oligomer at a concentration of less than or equal to about 0.5 g/ml, and when the draw solute has a water flux of greater than or equal to about 4 LMH at an osmotic pressure of about 20 atm.

16. The forward osmosis water treatment device of claim 9, further comprising an outlet configured to discharge treated water that is produced by removing the oligomer from the treated solution in the recovery system.

17. The forward osmosis water treatment device of claim 9, wherein the recovery system comprises a microfiltration (MF) membrane, an ultrafiltration (UF) membrane, a loose nanofiltration (NF) membrane, or a centrifugal separator.

18. A forward osmosis method for water treatment, comprising:
contacting a feed solution and an osmotic draw solution, the feed solution including water and materials to be separated dissolved in the water, the osmotic draw solution comprising a draw solute including a oligomer having an amino acid repeating unit with an ionic moiety and a counter ion, the oligomer including a repeating unit represented by Chemical Formula 1-1, a repeating unit represented by Chemical Formula 1-2, or a combination thereof; 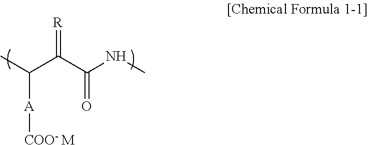
wherein R is hydrogen or a substituted or unsubstituted C1 to C10 alkyl group,
A is a direct bond or a substituted or unsubstituted C1 to C10 alkylene group, and M is a cation of an alkali metal or a cation of an alkaline earth metal; and 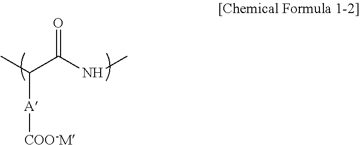
wherein A′ is a direct bond or a substituted or unsubstituted C1 to C10 alkylene group and M′ is a cation of an alkali metal or a cation of an alkaline earth metal, the feed solution and the osmotic draw solution being contacted with a semi-permeable membrane positioned therebetween to obtain a treated solution including water that has moved from the feed solution to the osmotic draw solution through the semi-permeable membrane by osmotic pressure;
removing the oligomer from the treated solution by filtration to obtain treated water; and
discharging the treated water.

19. The forward osmosis method for water treatment of claim 18, wherein the oligomer has a number-average molecular weight of about 500 g/mol to about 10,000 g/mol.

20. The forward osmosis method for water treatment of claim 18, wherein the counter ion comprises one of Na⁺, Li⁺, K⁺, Rb+, Ca²⁺, Mg²⁺, or Ba²⁺.
